(19) United States
(12) Patent Application Publication
(10) Pub. No.: US 2006/0294497 A1
(43) Pub. Date: Dec. 28, 2006

(54) SYSTEM AND METHOD FOR USE IN VISUAL MODELING

(76) Inventor: G (GRAHAM) C CHARTERS, Waltham Chase (GB)

Correspondence Address: IBM CORPORATION;INTELLECTUAL PROPERTY LAW, 11400 BURNET ROAD, AUSTIN, TX, 78758, US

(21) Appl. No.: 11/279,760

(22) Filed: Apr. 14, 2006

(30) Foreign Application Priority Data
Jun. 22, 2005 (GB) 05 12668.5

(51) Int. Cl. G06F 9/44

(52) U.S. Cl. 717/105

(57) ABSTRACT

A system and method for use in visual (e.g., UML) modeling are provided. According to one embodiment a method is disclosed which comprises providing a diagram of a model; defining predetermined focal points in the diagram; selecting one of the predetermined focal points and displaying the selected focal point at a scale to facilitate use of the displayed part of the model. In another embodiment the focal point is selected from a list of labels associated respectively with the predetermined focal points.

### CROSS-REFERENCE TO RELATED APPLICATIONS

The present application hereby claims benefit of priority to United Kingdom patent application number 0512668.5 entitled, “System and Method for Use in Visual Modelling,” filed on Jun. 22, 2005, naming G C Charters as inventor, assigned to the assignee of the present application, which is herein incorporated by reference in its entirety and for all purposes.

### BACKGROUND

1. Technical Field

This invention relates to development and maintenance of systems such as software applications utilizing visual development environments such as Unified Modeling Language (UML) layout.

2. Description of the Related Art

UML is a standard graphical language for modeling complex object-oriented systems. Further information on UML is available at Internet website www.uml.org. UML, at its simplest, is a language that graphically describes a set of elements. At its most complex, UML may used to model (e.g., specify, visualize, construct, and document) not only software systems but also business models and non-software systems. UML provides a graphical representation of a system design that may be used by developers to assure architectural soundness of a system. UML is frequently used to design the relationships between components (e.g., classes in the case of a Java program) before such components are developed and implemented in source code format.

Large diagrams for models (e.g., those created in UML modeling tools such as “Rational Rose”—an object-oriented UML software design tool intended for visual modeling and component construction of enterprise-level software applications) are difficult for a user to navigate in practice because the whole model at once cannot meaningfully be displayed on the user's screen. A user typically has to rely on remembering the diagram's layout and then using scroll bars to navigate to the place of interest. Diagrams can be split into sub-diagrams, but many people prefer to describe the model as a whole. There are a number of solutions to navigating large diagrams such as zooming in and out, but these are generic in use and bear no relevance to the information in the model being navigated.

Thus, modeling tools for designing/diagramming suffer the drawback that they usually need to display a large number of model elements (such as boxes) on screen, which elements may include additional data (annotations, characteristics, etc.) which it may also be desirable to view. Navigation of such large models can be arduous using horizontal and vertical scroll bars and zoom settings, and identifying an appropriate set of elements to be viewed on screen together at an appropriate level of zoom can be time-consuming.

A need therefore exists for a scheme for use in visual modeling wherein the above mentioned disadvantage(s) may be alleviated.

### SUMMARY

A system and method for use in visual (e.g., UML) modeling are provided. In one embodiment, a method is disclosed which comprises providing a diagram of a model; defining predetermined focal points in the diagram; selecting one of the predetermined focal points; and displaying the selected focal point at a scale to facilitate use of the displayed part of the model. In another embodiment the focal point is selected from a list of labels associated respectively with the predetermined focal points.

### BRIEF DESCRIPTION OF THE DRAWING(S)

One system and method for use in visual modeling incorporating the present invention will now be described, by way of example only, with reference to the accompanying drawing(s), in which:

FIG. 1 shows a schematic illustration of a UML diagram and ‘focused’ utilization thereof following the present invention.

### DETAILED DESCRIPTION

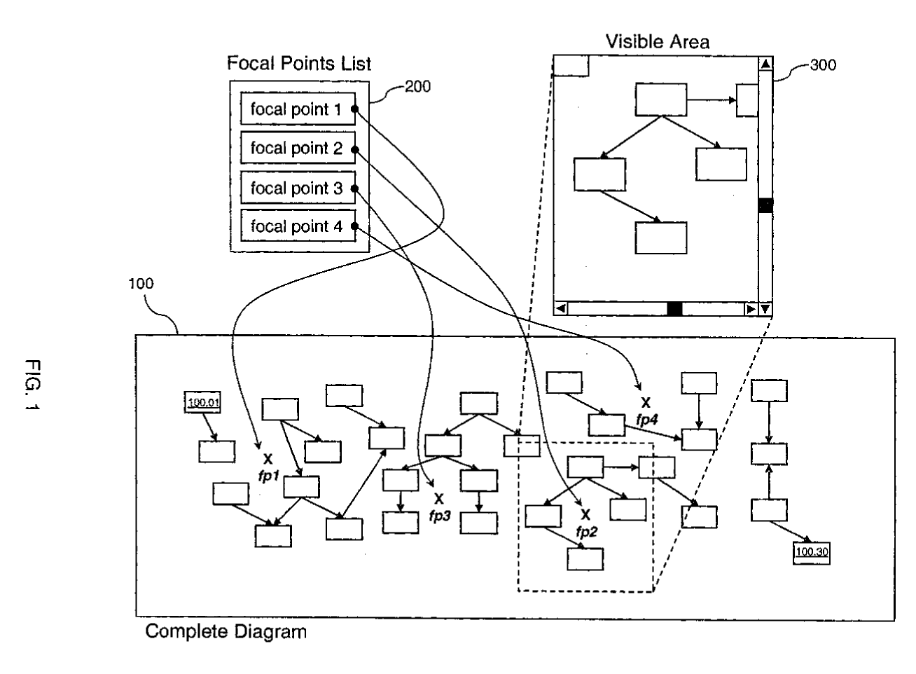

Referring now to FIG. 1, a complete diagram 100 of a software system modeled in UML comprises a large number of elements (such as software modules 110.01 . . . 100.30) connected as depicted by arrows. The size of the complete diagram 100 is far greater than can be useably displayed in the viewable screen area, since the large size of the diagram renders impractical its display as a whole on a user's display screen (not shown) at a magnification or scale to allow its easy use by the user. Heretofore, in order to display the diagram at a useful magnification the user would have to decide on a less-than-entire portion of the diagram for display and would then have to zoom the display to a satisfactory magnification and scroll the display (e.g., using horizontal and vertical scroll bars) in well-known manner so as to center the display at a desired position. This combination of zooming and scrolling is time-consuming and cumbersome.

In order to facilitate use of the UML diagram 100, a number of ‘focal points’ (depicted as X) in the diagram are defined, each focal point being a key point of interest in the complete diagram. In the diagram 100, four focal points (fp1, fp2, fp3, fp4) are illustrated.

The focal points can be selected by a user and the model will then be displayed with respect to the selected focal point. The focal points can be defined (e.g., by the user) in terms of a center of gravity of a number of model elements, or the focal point can be automatically defined by the system based on the relative positions of particular types of model elements. A center of gravity of a number of model elements in a set of model elements is a point which represents the set of model elements by its particular position. For example, the position of a center of gravity of a number of model elements can be a point which is equidistant from each of the model elements. Alternatively, the position of a center of gravity can be the center of a polygon formed by lines drawn between each of the model elements.

The model/diagram creator can annotate focal points in the model, by associating a label (in the diagram illustrated as “focal point 1”, “focal point 2”, “focal point 3” and “focal point 4”) with a focal point. A focal point label may thus be considered as identifying the center of a key point of interest in the diagram. The focal points may then be listed (such as in list 200) on the user's display screen, and when selected from the list (e.g., when, as illustrated, “focal point 2” is selected by positioning a cursor and clicking with a mouse—not shown—or via a keyboard—also not shown) the user's UML system would navigate directly to and display that point and its immediate surroundings in the diagram as visible area 300 on the user's display screen at a suitably high magnification to facilitate the user to view and work with the relevant elements of the UML model.

A number of ways are envisaged for capturing focal points and updating them as the model evolves. For example, a focal point could be defined as the center of gravity of a number of model artifacts; as these artifacts are moved or deleted, the focal point is recalculated. Alternatively, a focal point could be initially created as a discrete point in the model, but then have its nearest model artifacts calculated and its position preserved relative to those as the model is changed. A focal point could also be automatically determined from artifact classifications. For example, a model of software components might have those components classified into packages. These packages could be used to automatically define focal points in diagrams including those artifacts.

Thus, in a different context of a corporate data model defining entities pertaining to customers, orders and employees, the ability to label focal points in terms of the model would allow focal points to be labeled for example as “customers”, “orders” and “employees”.

It will be appreciated that the ‘focal point’ scheme described above is carried out in software running on a processor in one or more computers, and that the software may be provided as a computer program element carried on any suitable data carrier (not shown) such as a magnetic or optical computer disc.

In conclusion it will be understood that the system and method for use in visual modeling described above provides the advantages of allowing easy display and use of points (and surrounding areas) of interest in a complete diagram.

1. A system for use in visual modeling, the system comprising:
means for providing a diagram of a model;
means for defining at least one predetermined focal point in the diagram; and
means for selecting the at least one predetermined focal point and for displaying the at least one predetermined focal point at a scale to facilitate use of a displayed part of the model.

2. The system according to claim 1, wherein the means for selecting comprises means for displaying a list of labels, for user selection therefrom, associated respectively with a plurality of focal points including the at least one predetermined focal point.

3. The system according to claim 1, wherein the means for defining comprises means for defining the at least one predetermined focal point as substantially a center of gravity of a plurality of artifacts of the model.

4. The system according to claim 3 wherein the means for defining comprises means for recalculating the at least one predetermined focal point based upon a modification of at least one of the plurality of artifacts.

5. The system according to claim 1 wherein the means for defining comprises means for initially defining a discrete focal point in the model, and means for calculating at least one nearest model artifact and preserving a position of the discrete focal point relative to the at least one nearest model artifact as the model is changed.

6. The system according to claim 1 wherein the means for defining comprises means for automatically determining the at least one predetermined focal point from artifact classifications of the model.

7. The system according to claim 1 wherein the model comprises a Unified Modeling Language model.

8. A method for use in visual modeling, the method comprising:
providing a diagram of a model;
defining at least one predetermined focal point in the diagram; and
selecting the at least one predetermined focal point and displaying the at least one predetermined focal point at a scale to facilitate use of a displayed part of the model.

9. The method according to claim 8, wherein the step of selecting comprises displaying a list of labels, for user selection therefrom, associated respectively with a plurality of focal points including the at least one predetermined focal point.

10. The method according to claim 8, wherein the defining comprises defining the at least one predetermined focal point as substantially a center of gravity of a plurality of artifacts of the model.

11. The method according to claim 10 wherein the defining comprises recalculating the at least one predetermined focal point based upon a modification of at least one of the plurality of artifacts.

12. The method according to claim 8 wherein the defining comprises initially defining a discrete focal point in the model, and calculating at least one nearest model artifact and preserving a position of the discrete focal point relative to the at least one nearest model artifact as the model is changed.

13. The method according to claim 8 wherein the defining comprises automatically determining the at least one predetermined focal point from artifact classifications of the model.

14. The method according to claim 8 wherein the model comprises a Unified Modeling Language model.

15. A computer program element stored on a data carrier and comprising computer program means, which when executed by a computer, cause the computer to perform a method for use in visual modeling the method comprising:
providing a diagram of a model;
defining at least one predetermined focal point in the diagram; and
selecting the at least one predetermined focal point and displaying the at least one predetermined focal point at a scale to facilitate use of a displayed part of the model.

16-17. (canceled)
